(19) United States
(12) Patent Application Publication
(10) Pub. No.: US 2008/0086416 A1
(43) Pub. Date: Apr. 10, 2008

(54) SYSTEM AND METHOD FOR PROCESSING CHECKS

(76) Inventors: Shalar Vincent Alias, Atlanta, GA (US); John Andrew Morris, Atlanta, GA (US)

Correspondence Address: C. Brandon Browning;Sirote & Permutt, P.C., 2311 Highland Avenue South, Birmingham, AL, 35205, US

(21) Appl. No.: 11/535,558

(22) Filed: Sep. 27, 2006

(51) Int. Cl. G06Q 40/00

(52) U.S. Cl. 705/40; 705/45

(57) ABSTRACT

An electronic payment system provides a graphical interface, a communication module and an account engine. The graphical interface is configured to receive information from a banking instrument. The communication module is configured to present the banking instrument electronically to a drawee bank. The account engine is configured to receive a notification whether the banking instrument was processed by the drawee bank. The account engine is further configured to store the information from the banking instrument when the drawee bank denies processing the banking instrument. The banking instrument may be represented electronically to the drawee bank.

### FIELD OF THE INVENTION

This invention relates to processing of banking instruments. More particularly, this invention relates to a system and method for processing checks at a time temporally shifted from check acceptance.

### BACKGROUND OF THE INVENTION

Banking instruments suffer from a time lag between delivery of goods and services and the satisfaction of the debt related to the purchase of the goods and services. Various methods and systems, such as a POS Check Service (Point-of-Sale Check Service) attempt to minimize the risks associated with these time delays by reducing the delays by automating the processing and managing the banking instruments electronically.

The POS Check Service converts paper checks into electronic transactions at the point of sale by capturing the MICR (Magnetic Ink Character Recognition) data off the bottom of the check, using a check reader, and sending the data through the existing communications systems, such as the VisaNet SMS (Short Messaging Service) infrastructure. The POS check transactions are routed and processed similarly to debit or check card transactions. The service reduces the cost and risk of check acceptance by obtaining authorization directly from the check writer's bank.

Check cashing systems are unable to rely on the POS Check Service system at the time of service because checks are presented to the service provider prior to conversion. Conversion of the check generally occurs weeks after the service provider has already agreed to advance money to the customer. Cashing checks presented weeks prior is subject to non-sufficient funds charges that may not have been imposed at earlier dates when additional funds were located in the account. Moreover, check cashing institutions are unable to present the checks for cashing more than two times because the number of times a check may be presented for payment is limited to two times when the presenter receives a NSF notification. Generally, once the check has been presented for payment twice, check cashing institutions forward the unpaid account to loss prevention specialists who attempt to retrieve value from the account. Prevention specialists add additional costs and likely are unable to retrieve the full value of the account.

### SUMMARY OF THE INVENTION

An aspect of the invention provides an electronic payment system. The system comprises a graphical interface, a communication module and an account engine. The graphical interface is configured to receive information from a banking instrument. The communication module is configured to present the banking instrument electronically to a drawee bank. The account engine is configured to receive a notification whether the banking instrument was processed by the drawee bank. The account engine is further configured to store the information from the banking instrument when the drawee bank denies processing the banking instrument. The banking instrument may be represented electronically to the drawee bank.

Another aspect of the invention provides a method for processing electronic payments. The method receives account information from a banking instrument. The banking instrument is presented electronically to a drawee bank. The method receives a notification whether the banking instrument was processed by the drawee bank. The information from the banking instrument is stored when the drawee bank denies processing the banking instrument. The method represents the banking instrument electronically to the drawee bank.

Another aspect of the invention provides a method for processing banking instruments. The method receives an electronic banking instrument. The electronic banking instrument had previously been refused by a drawee bank for insufficient funds. The electronic banking instrument is presented to the drawee bank. The method receives a notification from the drawee bank stating whether the electronic banking instrument has been processed. The electronic banking instrument is represented to the drawee bank when the received notification is an insufficient funds notification until the electronic banking instrument is processed.

### BRIEF DESCRIPTION OF THE DRAWINGS

FIG. 1 is a block diagram of a processing system 10 according to an aspect of the invention.

FIG. 2 is a flowchart of steps according to an aspect of the invention.

FIG. 3 is a flowchart of steps according to an aspect of the invention.

FIG. 4 is a flowchart of steps according to an aspect of the invention.

FIG. 5 is a block diagram of a portion of the processing system of FIG. 1.

FIG. 6 is a block diagram of a portion of the system of FIG. 5.

### DETAILED DESCRIPTION OF PRESENTLY PREFERRED EMBODIMENTS

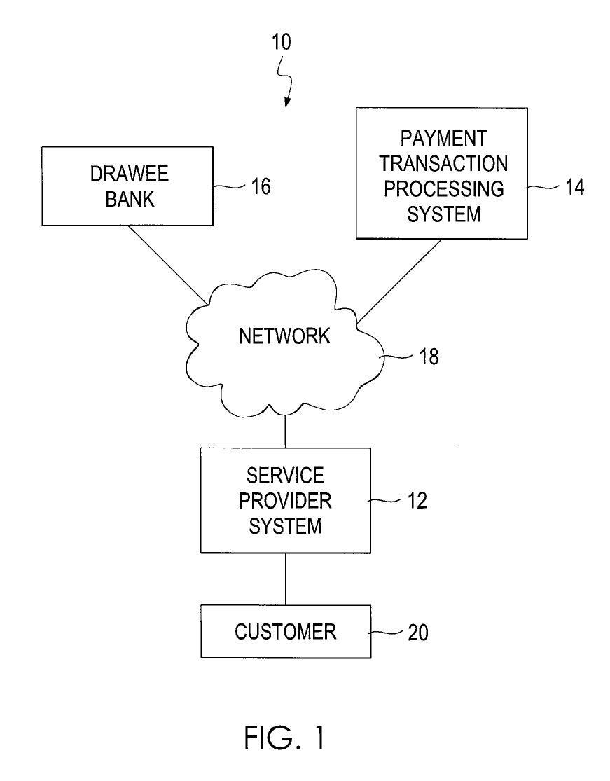

Turning now to the figures, FIG. 1 is a block diagram of a processing system 10 according to an aspect of the invention. The processing system 10 includes a service provider system 12 which communicates with a payment transactions processing system 14 and a drawee bank 16 through a network 18. A customer 20 initiates a transaction with the service provider system 12 for processing through the system 10. The service provider system 12 communicates with the payment transaction processing system 14 to present a check at the drawee bank 16 and receives funds through the payment transaction processing system 14 from the drawee bank 16 to satisfy a debt initiated in the transaction by the customer 20.

In traditional paper processing, the customer 20 presents a banking instrument such as a check to the service provider system 12. The service provider system 12 collects the checks at some prescribed time and prepares a deposit. The deposit, with the checks, is then taken to the service provider system 12 bank. The bank encodes each check and forwards them to the Federal Reserve Bank in its district. The Federal Reserve Bank then determines whether the drawee bank 16 for each check resides in its district. If not, the check is forwarded to the Federal Reserve Bank in the district where the drawee bank is located. Then, the check is sent to the drawee bank 16, which is the bank the customer's check is drawn on, and the amount of the check is debited from the customer's checking is account. Paper processing is a slow process, especially for out-of-town checks. Moreover, checks that are returned for non-sufficient funds are returned by physically sending the check back through the same channels. Delays in transportation may take weeks to complete a transaction. In addition, no centralized database exists in this model to report fraudulent activity which leaves service provider system 12 open to fraud.

In order to minimize fraud, prior to accepting the check from the customer 20 for payment, the service provider system 12 may run the check through a check reader. The data is transmitted to the payment transaction processing system 14 which uses a proprietary database consisting of data reported periodically to them by a plurality of service provider systems 12. Based on the information contained in its database, the payment transaction processing system 14 will make an accept or decline decision and forward that back to the service provider systems 12. The service provider system 12 then makes a decision whether to take the check, and if so, the service provider system 12 processes the check as a paper item.

The payment transaction processing system 14 runs on VisaNet, the largest payment transaction processing system in the world. The VisaNet infrastructure is already in place and has the potential to connect to 90% of all checking accounts in the United States and 4.9 million U.S. merchants. The payment transaction processing system 14 offers the flexibility of selecting the service option that best meets payment transaction processing system 14 needs. The payment transaction processing system 14 may access consumer's checking online through VisaNet. In addition, the debiting of the check to the consumer's account occurs online through the payment transaction processing system 14 rather than through the Federal Reserve Bank.

A transaction may be conversion only, verification with conversion or guarantee with conversion. In a conversion only transaction, a check is converted at the point of sale into an electronic transaction. The drawee bank 16 through the payment transaction processing system 14 determines whether the checking account is open or closed and will send the authorization back to the service provider system 12. The service provider system 12 retains the risk of loss. In a verification with conversion transaction, the check is converted into an electronic transaction and the drawee bank 16 through the payment transaction processing system 14 determines whether the account is open or closed and whether funds are available at the time of inquiry. The service provider system 12 retains the risk of loss. In a guarantee with conversion transaction, a check is converted at the point of sale and the guarantor effectively “buys” the paper. If the drawee bank 16 is the guarantor, the drawee bank 16 may place a memo-post on funds in the checking account so that payment will be guaranteed. The guarantor performs the steps of a verification with conversion transaction, namely verifying the account is open and verifying funds are in the account, prior to making the guarantee. In this transaction, the guarantor bears the risk of loss.

Processing through the payment transaction processing system 14 allows access to the consumer's bank for check authorization through one of the authorization transactions. The access ensures accurate information about the consumer's check, which reduces check fraud and uncollectible checks. Moreover, access through the payment transaction processing system 14 may reduce access and collection fees, as described below.

The service provider system 12 is configured to make paper transactions electronic. By making the transactions electronic, the service provider system 12 reduces check is handling at the point of sale and back office and streamlines processes. Additionally, the service provider system 12 turns each paper check into an electronic funds transfer which may debit the consumer's checking account via online posting.

When the service provider system 12 is a delayed check cashing system, the service provider system 12 may receive a check and advance money to a customer based upon a future date for presenting the check to the drawee bank 16. The customer 20 is able to receive an advance on funds expected at a later date. When the date on the check arrives, the service provider system 12 submits the check through the payment transaction processing system 14 to process the check at the drawee bank 16. Because the account in the drawee bank 16 is being processed through the payment transaction processing system 14, the service provider system 12 may present the check for payment without realizing non-sufficient funds charges (NSF) if the account does not have sufficient funds. Instead, the payment transaction processing system 14 returns a message stating the transaction cannot be processed. Because the message does not incur the fees associated with a NSF, the check may be kept until a later date when the account in the drawee bank 16 is more likely to contain the funds. Moreover, because the transaction is completed electronically, a transaction may be processed immediately electronically, instead of processing the transaction through the normal paper steps, which may place the transaction behind other transactions awaiting processing in the account.

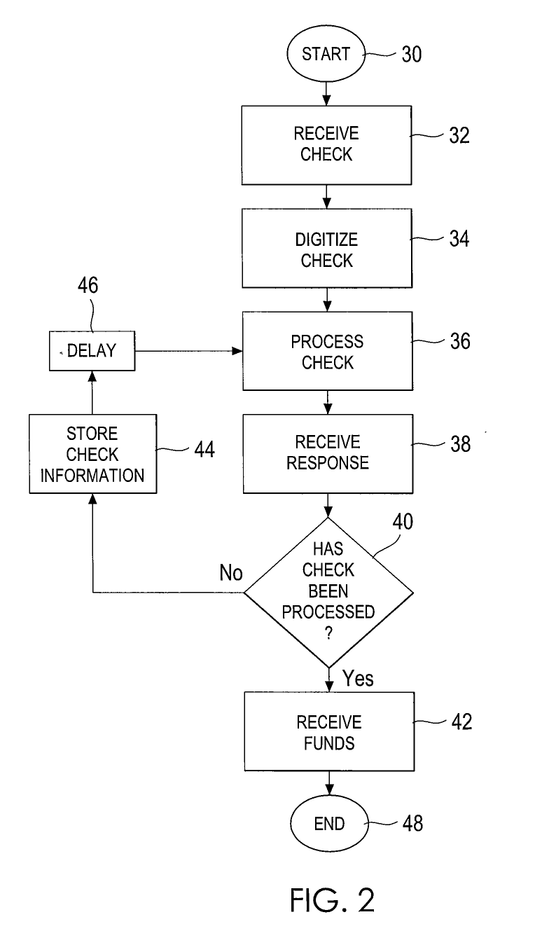

Turning now to FIG. 2, FIG. 2 is a flowchart of steps according to an aspect of the invention. The method begins in step 30. A check is received in step 32. The check is digitized in step 34. In step 36, the check is processed. A response is received in step 38 and a decision is made in step 40 to determine whether the check has been processed.

If the decision step 40 returns a processed check, then funds are received in step 42. If the check is not processed in step 40, then check information is stored in step 44, and the method delays processing in step 46. Once the delay of step 46 has lapsed, then the check is passed back to step 36 for processing. After the funds are received in step 42, then the method ends in step 48.

When a check is received in step 32, the customer receives an advance less than the amount of the check. Because the advance is made prior to presentment at the drawee bank, the determination whether checks may be processed in step 40 is temporally removed from the transaction. The delay between advancing money and cashing the check makes lack of funding more likely, but because the method allows for additional attempts to process the check, the checks are more likely to process.

When a check is digitized in step 34, the method captures the MICR (Magnetic Ink Character Recognition) data off the bottom of the check, using a check reader, and digitizes the data for processing. The data includes an ABA bank identifier, an account number, an amount, and a check number. Other information like the name, date of processing, and address information may also be read from the check. The digitized information is stored.

For a check cashing system, a delay may exist between steps 32 and 36. The delay may be prior to the digitizing step of step 34, or may be after the digitizing step 34. If the check is digitized prior to the delay, then the digitized check is stored. In one embodiment, a reminder may be set to remind a user to process the check in step 36. In another embodiment, the check may be processed in step 36 on a given date. For example, on the date the check becomes due. The delay of step 46 may also be set as a reminder for a user, is or may define a delay for processing. In one embodiment, the delay 46 may be set for two weeks after the initial due date. In another embodiment, the delay 46 may be set to coincide with possible pay cycles, for example, the 15^{th} and last day of every month, or every Friday. A user may be able to set the delay 46 according to any known patterns of the customer.

Processing step 36 initiates the presentment process with the drawee bank. The by implementing a payment transaction processing system such as VisaNet allows for processing to occur when funds are sufficient. The payment transaction processing system processes the check by sending the account information and check number to the drawee bank identified in the digitized data of step 34. The method allows for additional processing attempts through steps 44 and 46 until the processing is completed and funds are transferred in step 42 from the drawee bank to the service provider system.

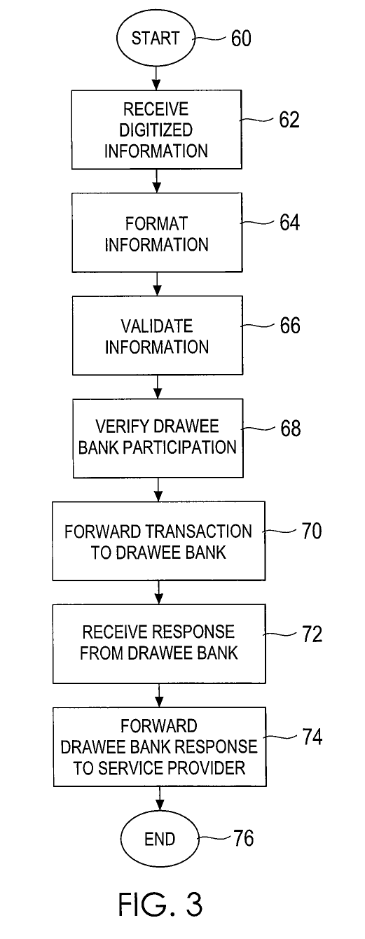

Turning now to FIG. 3, FIG. 3 is a flowchart of steps according to an aspect of the invention. The method starts at step 60. Digitized information relating to the check transaction is received in step 62. In step 64, the information is formatted. The information is validated in step 66. In step 68, the drawee bank, determined from the information received in step 62 is verified as a participant to the payment transaction processing system. When the drawee bank is verified, then the transaction is forwarded to the drawee bank in step 70. The method receives a response from the drawee bank in step 72. The response is forwarded to the service provider system in step 74 and the method ends in step 76.

The steps of FIG. 3 may be performed in the payment transaction processing system of FIG. 1 with information received from the service provider system. The payment transaction processing system receives transaction information from the service provider system of FIG. 1. The information received in step 62 is the information from the digitized check. Because the service provider system may include additional information about the transaction that is not required by the drawee bank in order to complete the transaction, the payment transaction processing system may strip some of the information from the transaction before sending the transaction to the drawee bank. Thus, the method of FIG. 3 formats the transaction in step 64 in order to prepare the transaction for processing by the drawee bank. In step 66, the information is validated to ensure all the necessary information is included for communication to the drawee bank.

Interaction with the drawee bank includes communications meant to complete the transaction. The method verifies the bank participates in the payment transaction processing system in step 68. Banks may elect to offer electronic processing of its check, for example, through the VisaNet system, or may elect to not allow electronic processing. The bank's choice may be based upon a perceived value to customers measured against cost and loss protection. If the bank does not participate, then the method of FIG. 3 should not proceed as the transaction may not be completed. Once the bank is verified as participating, then the method forwards the formatted information regarding account number and check number to the bank in step 70 and awaits a reply in step 72. The reply may include a positive response (the account is open and includes funds sufficient to cover the amount of the check) or a negative response. A positive response also includes a transfer of the amount of money of the check. The completed response is forwarded to the service provider system in step 74 so that the service provider system may process the transaction. The method ends in step 76 after the response is forwarded to the service is provider system.

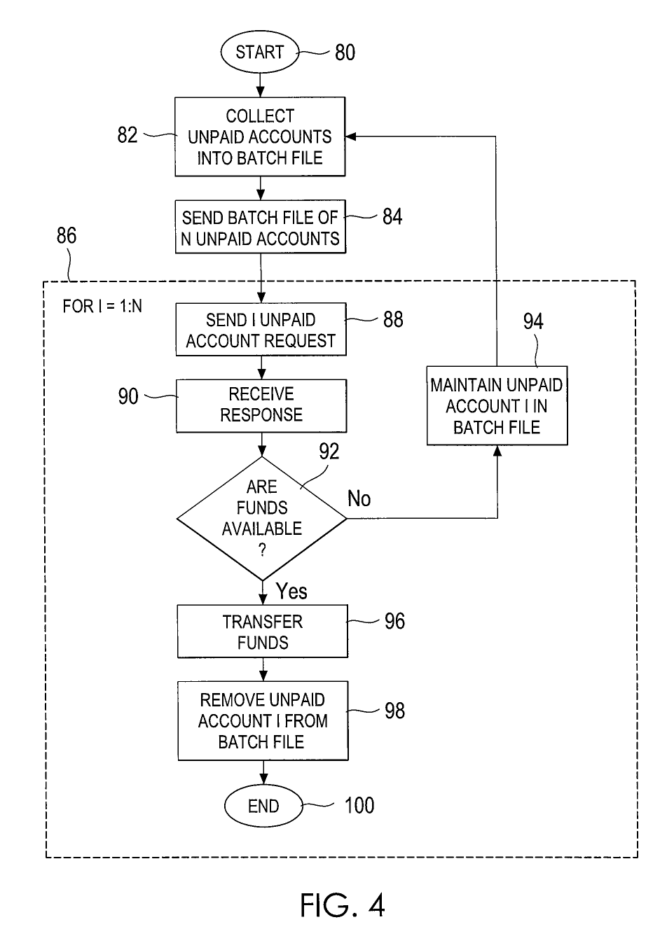

Turning now to FIG. 4, FIG. 4 is a flowchart of steps according to an aspect of the invention. The method starts in step 80. In step 82, unpaid accounts are collected into a batch file. The batch file is sent to the payment transaction processing system having N unpaid accounts. Iterative steps 86 are performed to attempt collection on each of the N unpaid accounts.

The iterative steps 86 begin in step 88 where the first unpaid account request is sent from the payment transaction processing system to the drawee bank. A response is received from the drawee bank in step 90. The method determines if funds are available in step 92 based upon the received response in step 90. If no funds are available, then step 94 maintains the unpaid account in the batch file by returning the account information to step 82. If funds are available, then funds are transferred in step 96. The now paid account is removed from the batch file in step 98. After the iterative steps 86 are completed for the N unpaid accounts, then the method ends in step 100.

The iterative step 86 is performed individually for each account because drawee banks may be different for different accounts, and the method at the drawee banks that accepts the transaction requires individual transactions. The iterative steps 86 may not require the validation and verification steps 66 and 68 of FIG. 3 because these transactions have already been forwarded to the drawee banks prior to being included in the batch file. There may be a desire to validate the transactions prior to sending the transaction in step 88, in order to protect against data corruption.

In step 82, the unpaid accounts are collected into a batch file. The batch file may be controlled at the service provider system so that the batch file may be run according to a is schedule determined by the service provider system. A transaction of a customer may be automatically entered into the batch file after the due date arrives, or may be manually placed into an account by the service provider system. The service provider system is likely the most knowledgeable person in determining when an unpaid account should be processed. Thus, it may be better for a service provider system to keep an account out of the batch file for processing at times different from the processing schedule of the batch file.

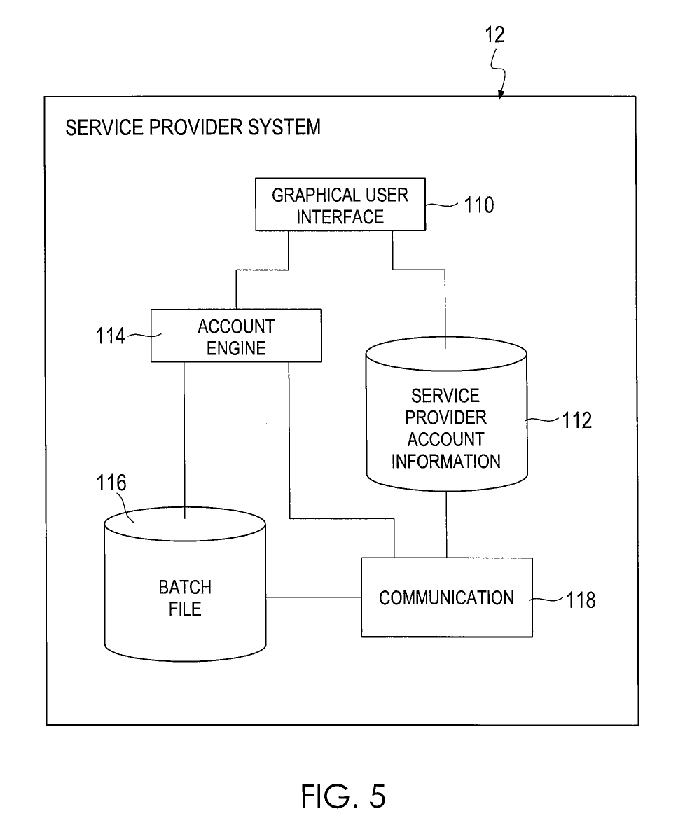

Turning now to FIG. 5, FIG. 5 is a block diagram of a portion 12 of the processing system of FIG. 1. The server provider system 12 includes a graphical user interface 110, a service provider account information 112, an account engine 114, a batch file 116, and a communication module 118. The graphical interface 110 communicates with the account engine 114 and the service provider account information 112 in order to present the account information to the user graphically. The communication module 118 provides access through the network to the payment transaction processing system for the batch file 116, the account engine 114, and the service provider account information 112.

The communication module 118 is configured to communicate with the payment transaction processing system. The communication module provides account information to the payment transaction processing system for processing of a transaction, and receives the communications from the payment transaction processing system for the service provider account information 112 and the batch file 116. The communication module 118 may include an Ethernet connection, a wireless access card configured to communicate with a WLAN, a modem, or other communication devices capable of accessing the payment transaction processing system. The communication module 118 sends transaction information, such as whether the transaction was completed or returned for insufficient funds, and the initial transaction information, to the batch file 116 and the account engine 114. The communication module 118 sends information related to completed transactions, such as the money transferred and any confirmation codes from the drawee bank to the service provider account information 112.

The account engine 114 processes the information received from the graphical user interface 112 for storage in the batch file 116 or processing through the communications module 118. The account engine 114 forwards response information received from the communication module 118 to the graphical user interface 110 so that a user may review the transaction details. The account engine 114 performs the steps required to process the transaction. When the information is processed, if the transaction is ready for processing, then the transaction is forwarded to the communication module 118. If the transaction is not ready for processing, then the account engine 114 sends the transaction to the batch file 116.

The graphical user interface 110 is configured to digitize the transaction, set transaction dates, and present updates of the transaction to a user. The graphical user interface 110 may accept input from a MICR, keyboard, mouse, or other input devices. Information from the MICR includes the bank account number and the ABA bank number. Other information input by a user may include the amount of the transaction, date the transaction should be processed, customer name, address or other contact information. The graphical user interface 110 also displays transaction information received from the account engine 114, including whether the transaction was completed. The graphical user interface 110 may also display information specific to the service provider system 12 through the service provider account information 112.

The service provider account information 112 is configured to store information related to completed transactions. When a drawee bank sends a completed transaction back to the service provider system 12, the drawee bank forwards notification of funds to the service provider account information 112. The service provider account information 112 stores the notification of funds transferred and the original transaction account information stored in the batch file so that a user may verify through the graphical user interface 110 that a transaction was completed and may trace the funds in its account.

The batch file 116 includes the information on unprocessed transaction. Such transactions may be unprocessed because the due date has not arrived, or the transaction was returned for insufficient funds. Entries in the batch file 116 may include details such as when each individual entry should be reprocessed, or entries for when the entire batch file 116 should be processed, assuming the due date for the transaction has passed. The batch file 116 may also be set to be processed manually, where a user is able to process account transaction individually through the graphical user interface 110.

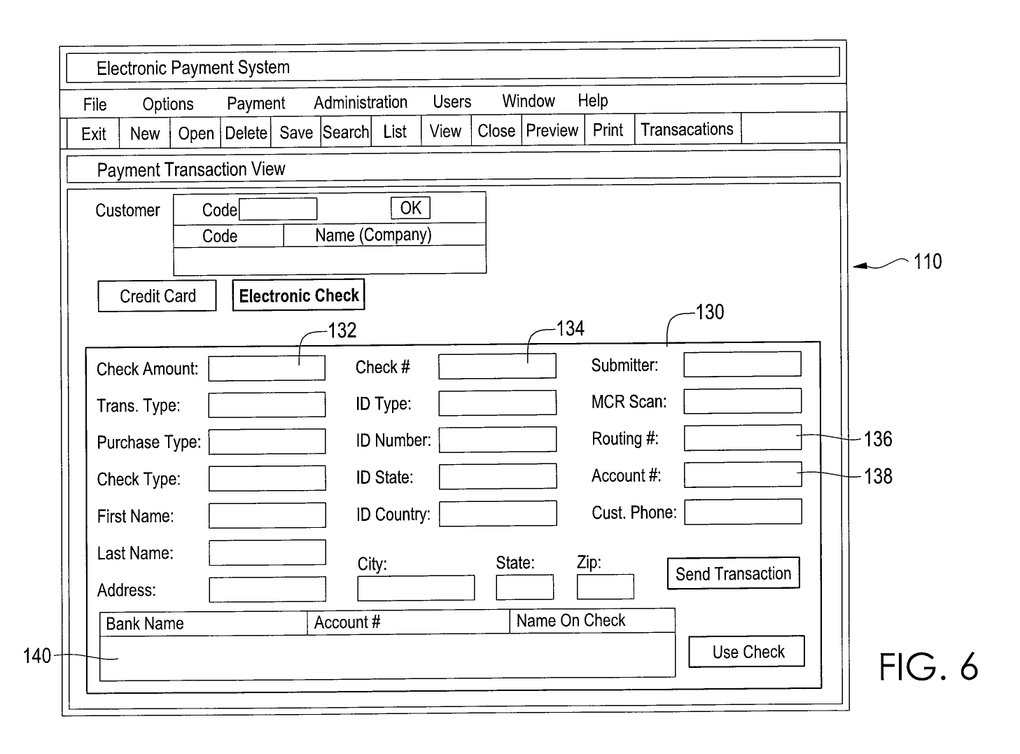

Turning now to FIG. 6, FIG. 6 is a block diagram of a portion 110 of the system of FIG. 5. The graphical user interface 110 includes an account record 130 including a check amount, a check number, a routing number 136, an account number 138 and a verification screen 140. The routing number 136 and the account number 138 are preferably processed through the MICR. Information such as check amount 132 and check number 134 are preferably input through a keyboard and mouse. Other information in the record 130 may be manually input or retrieved from stored information from previous transactions.

The display box 140 may display information related to the transaction. The display may notify the user that the check is deficient. For example, the bank name, retrieved based upon the account number, may not match with the name on the check upon visual inspection of the check. Such an instance could occur if a customer was producing fake checks and using the MICR number off of an old check.

While the display shown in FIG. 6 displays a single instance of the graphical user interface 110, the graphical user interface, through the tool bars and menus at the top of the graphical user interface 110. The graphical user interface 110 includes displays for administration, payment review, transaction control (including control of the batch file) and printing capabilities. The user may control processing of the batch file fully, or may allow the user to individually process the account transaction.

As will be apparent to one skilled in the art, various modifications can be made within the scope of the aforesaid description. Such modifications being within the ability of one skilled in the art form a part of the present invention and are embraced by the claims below.

It is claimed:

1. An electronic payment system, comprising:
a graphical interface configured to receive account information from a banking instrument;
a communication module configured to present the banking instrument electronically to a drawee bank; and
an account engine configured to receive a notification whether the banking instrument was processed by the drawee bank and further configured to store the information from the banking instrument when the drawee bank denies processing the banking instrument so that the banking instrument may be represented electronically to the drawee bank.

2. The system of claim 1, further comprising a payment transaction processing system is configured to be in communication with the drawee bank and the communication module wherein the communication module presents the banking instrument to the drawee bank through the payment transaction processing system.

3. The system of claim 2, wherein the payment transaction processing system is VisaNet.

4. The system of claim 1, further comprising a batch file configured to store the banking instrument prior to the day the banking instrument is scheduled to be presented.

5. The system of claim 4, wherein the batch file is further configured to store the banking instrument after the drawee bank denies processing the banking instrument.

6. The system of claim 5, wherein the batch file is further configured to store a future date for representing the banking instrument to the drawee bank.

7. The system of claim 6, wherein the batch file is configured to represent all of the banking instruments stored in the batch file on the future date.

8. The system of claim 5 wherein the graphical interface is configured to display individual banking instruments from the batch file and further configured to represent the banking instrument to the drawee bank after the graphical interface receives a command from a user to represent the banking instrument.

9. The system of claim 1, wherein the banking instrument is a check digitized into an electronic form.

10. The system of claim 1 wherein the electronic payment system is a payday check cashing store.

11. A method for processing electronic payments, comprising the steps of:
receiving account information from a banking instrument;
presenting the banking instrument electronically to a drawee bank;
receiving a notification whether the banking instrument was processed by the drawee bank;
storing the information from the banking instrument when the drawee bank denies processing the banking instrument; and
representing the banking instrument electronically to the drawee bank.

12. The method of claim 11, further comprising the step of communicating with a payment transaction processing system configured to be in communication with the drawee bank wherein the banking instrument is presented to the drawee bank through the payment transaction processing system.

13. The method of claim 12, wherein the payment transaction processing system is VisaNet.

14. The method of claim 11, wherein the storing step further comprises storing the banking instrument prior to the day the banking instrument is scheduled to be presented.

15. The method of claim 14, wherein the storing step is further configured to store a future date for representing the banking instrument to the drawee bank.

16. The method of claim 15, wherein the presenting step is further configured to represent all of the banking instruments stored in the storing step on the future date.

17. The system of claim 14 further comprising the steps of:
displaying individual banking instruments stored in the storing step;
receiving a command to represent the banking instrument; and
representing the banking instrument to the drawee bank.

18. A method for processing banking instruments, comprising:
receiving an electronic banking instrument, the electronic banking instrument having previously been refused by a drawee bank;
representing the electronic banking instrument to the drawee bank; and
receiving a notification from the drawee bank wherein the notification states whether the electronic banking instrument has been processed;
wherein the electronic banking instrument is represented to the drawee bank until the electronic banking instrument is processed by the drawee bank.

19. The method of claim 18, wherein the representing step is further configured to store a future date for representing the banking instrument to the drawee bank.

20. The method of claim 18, further comprising the steps of:
receiving a plurality of electronic banking instrument having previously been refused by a drawee bank for insufficient funds;
individually representing the received banking instruments;
receiving a notification for each individually represented banking instrument; and
storing the banking instrument when the notification states the banking instrument was not processed.
